(19) United States
(12) Patent Application Publication
(10) Pub. No.: US 2011/0228463 A1
(43) Pub. Date: Sep. 22, 2011

(54) Laptop Back-to-Back Display Screen System for Face-to-Face Interactions

(76) Inventor: James D. Matagne, Sequim, WA (US)

(21) Appl. No.: 13/053,812

(22) Filed: Mar. 22, 2011

Related U.S. Application Data
(60) Provisional application No. 61/316,329, filed on Mar. 22, 2010.

(51) Int. Cl. G06F 1/16

(52) U.S. Cl. 361/679.04

(57) ABSTRACT

Computer display systems comprising back-to-back (BTB) dual screens that render the same display simultaneously on a primary and a slaved secondary screen, for face-to-face inter-active and collaborative purposes, inter alia, for education, sales, presentation, and collaboration between two or more persons. The inventive system is particularly suitable for laptop and netbook types of computers, and a wide range of integrated and accessory BTB dual-screen configurations are disclosed. The secondary screen can be rotated between the BTB dual screen collaborative orientation to an SBS GEM configuration for multi-screen display only to the user.

### CROSS-REFERENCE TO RELATED APPLICATION

This is the Regular US Application of Provisional Application Ser. No. 61/316,329 of the same title filed by the same inventor on Mar. 22, 2010, the priority of which is claimed under 35 USC §§111 ff, including §§119 and 120.

### FIELD OF THE INVENTION

The present invention relates to computer display systems, and more particularly to back-to-back (BTB) dual screens that render the same display simultaneously on a primary and a slaved secondary screen, for face-to-face interactive purposes, inter alia, of education, sales, presentation, and collaboration between two or more persons. The inventive system is particularly suitable for laptop and netbook types of computers, and a wide range of integrated and accessory BTB dual-screen configurations are disclosed.

### BACKGROUND

In many service professions, such as financial advisory services and banking, educational services, insurance services, computer training, legal services, real estate, and the like, the professional and client/customer/prospect sit on opposite sides of a desk or table for face-to-face consultations. However, only one person at a time can see items displayed on screen, and the screen must be turned back and forth between the two parties.

Taking for example, bank financial advisory services, typically, a bank financial advisor (FA) sits on one side of a desk with a laptop hooked to a network (Internet, LAN, or WAN) to access a range of financial products from a menu offered by the bank, while the client or prospect sits on the opposite side. This seating is preferred as it permits a highly face-to-face presentation and interchange, without it being unduly intimate and distractive, as would be the case where both parties sat on the same side of the desk. The FA suggests a particular financial product, say a mutual fund, and the client requests information on its recent performance on the stock market. The FA calls up the product by its 4-letter code, and a page or more is displayed, typically both text and a graph of the performance. However, that is visible only to the FA. So the FA then pivots the whole laptop around 180° so that the client can see the graph. However, if the client asks a question about something on the graph, the FA cannot see where the client is pointing, so the FA must swivel it back around, try to figure out what was being asked about and respond or interactively change the display, e.g., enlarge it, move a cursor to display to show some critical indices, such as a moving average, the intersection of moving average with the market close graph to show inflection points, and the like. The FA then turns the display back to the client, loosing sight of it again, and hoping that the client follows. Typically, so much is lost in the constant rotation back and forth that the point is lost, the presentation falls flat, and the client is no better informed than before.

An example is the recent RBC (Royal Bank of Canada) TV commercial of the Fall of 2009, wherein a client and RBC FA are on opposite sides of the desk, and as the RBC FA talks about a bank product, turns the computer toward the client. The bank may be trying to tell the television viewer that RBC is computer savvy, but is blind to the fact that the situation demonstrates the silliness of rotating computer displays. Then again, RBC may be aware of the issue, as the commercial stops the turn of the display to face the viewer, located at 90° to both the FA and the client.

A similar situation is in computer training. In classrooms, the instructor uses an overhead that shows the display on a large pull-down screen at the front of the class, while individual computer screen displays and client computers are at, or linked to each student station. However, the student must look both at the screen at the front of the class and at his/her own monitor display and attempt to manipulate a mouse to follow the steps taken by the instructor. It is no better in one-on-one tutorial work, wherein the instructor sits beside the student and talks the student through the navigation steps.

Often a professional must give a PowerPoint slideshow. The laptop is hooked to a projector, and the image of the laptop screen is displayed by the projector on a wall or pull-down screen. Often the room is well lit, or the projector simply does not have the lumen rating needed to project a decent image on wall or screen. Further, there are often incompatibilities in getting the projector to find the laptop, and they must be hooked up and turned on in the proper sequence for the projector to acquire the laptop and to project any image. If the projector bulb burns out, the presentation is dead. Where the speaker attempts to turn the laptop around so the screen faces the audience, in order to see the screen, the speaker must turn his/her back to the audience, which kills any body language and facial expression interaction with the audience.

In smaller group situations, e.g., tutorial, real estate, personal banking, insurance and the like where the professional is one-on-one with one or a few client(s), it is vital to maintain the face-to-face

One current line of computer display configurations that has a growing user share is that of multiple display screens, offered as Graphic Expansion Modules (GEMs). These are universally side-by-side (SBS) screen geometry configurations. The SBS geometry is designed for use in the fields of gaming, graphic design, and to a lesser extent, office spread-sheet applications, in which each screen renders a different graphic or a different portion of an overall integrated graphic.

The Gscreen spacebook was touted to launch in December 2009, featuring 15′-17″ SBS pull-out screens, with 13″-14″ screens to come later. Lenovo is scheduled to offer a ThinkPad W700 computer having a single, half-sized (mini) secondary SBS screen that pulls out to the right. Asus showed a prototype dual SBS touch-screen in March 2009, but there is no announced production schedule as of November 2009. Kohjinsha showed a 10.1″ SBS dual screen notebook in October 2009, but again no announced production schedule as of November 2009. Gizmodo.com shows a mock-up or prototype V12 Design dual screen laptop in which one screen is orthogonal to another, a horizontal screen serving as a virtual keyboard, the second screen can either face the user or be flipped over to face someone opposite. However, from the limited information available, it does not appear that the user and client can see the same information simultaneously. That is, like other dual screen designs, the two screens render different images, and the horizontal screen appears to be a dedicated virtual touch-screen keyboard.

Such prior art systems are deficient in that they simply spread graphics over more screen real estate, and employ dual or more smaller screens in place of single, larger and much more expensive screens. Thus Matrox offers the DualHead2Go external multi-monitor GEM device that permits a user to add up to two additional, separate monitors to his/her notebook or desktop computer. The GEM box of Matrox is offered in analog, digital and DP versions that lets the user run different applications on each monitor or view one application across two monitors (e.g., a game or spread sheet). Thus the user, instead of buying a 30″ monitor for $2500, saves $1500 by buying two 19″ monitors and the Matrox GEM box, and splits the image across both monitors. The development of GEM devices has resulted in stunting the trend to mega-monitors (>23″).

Accordingly, there is an unmet need in the art for a universal BTB dual monitor geometry that permits a user to show a client, customer, student, prospect exactly what the user is seeing, while at the same time maintaining the vital face-to-face interactivity that is needed for and accompanies successful presentations.

### THE INVENTION

### Summary, Including Objects and Advantages

The invention comprises back-to-back computer display systems, and more particularly to back-to-back (BTB) dual screens that render the same display simultaneously on a primary, user facing screen, and a slaved secondary screen pivotable to face 180° opposite the primary screen, for face-to-face interactive purposes between the user and a second person, such as a client, customer or student. The inventive BTB dual screen architecture has wide use for interaction and collaboration between two or more persons, inter alia, in the fields of education, sales, advisory services and presentations. The inventive system remedies the deficiencies of the prior art discussed above and is particularly suitable for laptop and netbook types of computers, and a wide range of integrated and accessory BTB dual-screen configurations are disclosed.

In a first embodiment, a laptop computer is fitted with a secondary screen, pivotally hinged to the primary screen at the top of the primary screen, e.g., at the vertical side margins of the primary screen or by means of a partial or full piano-type hinge along the top margin. The secondary screen can be pivoted a full 180°, in the following positions:
1. from a first, closed/carry position, in which the two screens are face to face,
2. to a second, vertically open position in which the secondary screen is positioned above the primary screen and is facing in the same direction as the primary screen, and thence
3. to a third, fully opened, folded back, client display position in which the secondary screen faces the direction, generally 180° opposite the primary screen, although for ergonomic ease of viewing, the included angle between the screens is on the order of from about 10° to about 45°.

In the second position, the secondary screen optionally serves the user presenting a second display which the user can employ to render extensions of the document or graphic image on the primary screen or for a different document or image. For example, a document can have multiple pages rendered with sequential pages rendered above and below, with page 1 above and page 2 below. As the user scrolls down, page 2 slides to the top, secondary screen and page 3 is rendered on the lower, primary screen, and so on. This is particularly useful for vertically long format documents, such as A4, Legal page, and print media column formats.

In this first embodiment, the backs of each screen module are hard-backed, in conventional laptop case format. When in the third, client display open position, the hardbacks of each screen face each other. When in the screens are arrayed in the second vertically open position, the hardbacks are generally in the same plane, although the upper may be truly vertical and the lower in a somewhat tilted-back orientation. When the screens are folded together in the closed position, the hardback of the primary screen is the outer top surface of the closed laptop, and the secondary screen hardback faces the keyboard.

In this first embodiment, as seen from edge on, the closed laptop has three layers: A) the lower layer being the keyboard-containing module which also includes the main laptop components of CPU processor, RAM and ROM memories, media drive(s), battery, charger, power supply, wireless and GPU cards, I/O ports, flash media slots, external power cord socket, and the like; B) an intermediate layer not hinged to the lower layer, which contains the secondary display screen module; and C) the outer layer, hinged to the lower layer at one end and to the intermediate layer at an opposed end, which comprises the primary display screen module. The hinge between the primary screen module and the keyboard module is extended or raised, sufficiently to permit the secondary screen to be folded in the closed position face to face with the primary screen.

The GPU and operating system is selected to selectively support two screens in either an identical or split mode, that is, to render the same graphical image on both the primary and secondary screen or different images. The secondary screen power and data cabling to/from the Power Supply/CPU/GPU, passes through the housing of the primary screen and thence to the secondary screen connectors.

In a second embodiment, the secondary screen is rotationally suspended and hinged along a horizontal axis disposed medially along one side margin of the primary screen. As in the first embodiment, the primary screen is supported on extended hinges along a bottom edge. The second embodiment laptop when closed is a three-layer articulated assembly with the screens in the same first, face to face position as in the first embodiment. Once the primary and secondary screen modules are raised to the normal screen position of a laptop, the secondary screen module can unfold horizontally to a second position in which both screens face the user, but the screens are side-by-side, to function as a normal SBS GEM. Then the secondary screen can be pivoted on the horizontal medial axis into the third position to face a customer/client/student facing the user, that is, so the secondary screen is facing the opposite direction as the user primary screen. As with the first embodiment, the power and digital information cabling for the secondary screen passes through the primary screen along one edge, thence through the hollow axis of the horizontal pivot and thence to the secondary screen connectors. In this second embodiment, the secondary screen can be tilted back at the top for better ergonomic viewing by the client/customer/student, while the primary screen can be tilted back at its top for ergonomic viewing by the user.

In a third embodiment, the secondary screen module is hinged at the top to the top of the primary screen by a living or piano-type hinge, and is oriented with the screen outward, that is facing opposite the primary screen viewing direction. To protect the secondary screen when stored or travelling, a snap-on cover is provided. In addition, the viewing angle, relative to the primary screen is adjustably locked by a variety of methods, including a lock knob at the top hinge, relatively stiff V-hinges, one on each side margin, and the like. The cabling passes through the primary screen to the secondary via the hollow top hinge.

In a fourth embodiment, the secondary screen is not hinged permanently to the primary screen, but rather is a free-floating module with one or more hooks at the top marginal edge to engage the top marginal edge of the laptop, one or more retractable feet at the bottom of the secondary screen with a non-skid bottom foot to permit the secondary screen to be propped at an angle to the primary screen. The cabling may be free, plugged into the USB (2.0, 3.0), Firewire, VGA or RCA port of the laptop. This embodiment is an example of a retrofit implementation of the BTB dual display architecture of the inventive computer system.

One skilled in the art will appreciate that the inventive system permits the secondary monitor to be used in both a SBS GEM configuration and a BTB collaboration configuration. Thus, the user can be using, for example, the second embodiment in a SBS GEM configuration for private work, and the secondary monitor flipped around to face a client/customer/student as needed, with the Display being selected to be slaved to the primary by appropriate selection in the Control Panel option menu. One skilled in the art will readily appreciate that a wide range of hinges, pivots and connection means may be designed and implemented without undue experimentation for the BTB configuration functionality described herein. The inventive BTB computer architecture is a simple and inexpensive alternative to a second computer or a second large monitor that cannot be easily carried in the field, and which does not take up additional desk real estate. The advantages of the user professional being able to both visually face and speak to his/her client while demonstrating exactly what the professional is looking at or keying into the keyboard is enormous; in effect it makes the computer experience personal again.

Although in the four non-limiting exemplary embodiments above, the secondary screen is a slave without keyboard or mouse input possible by the customer/client/student, in a fifth embodiment, the secondary screen, or both screens may be touch, motion or capacitance activated so that both parties can manipulate images or enter data by suitable touch, hand or wand motion. In a preferred version of the third embodiment, the secondary, or both the primary and secondary screens are OLED screens, with the two screens being packaged in a single module so that the secondary screen is on the otherwise “outside” surface of the laptop, and provided with a protective cover or integrated laminated, transparent, robust polymer protective layer.

### BRIEF DESCRIPTION OF THE DRAWINGS

The objects, features, and advantages of the present invention will be evident when considered in conjunction with the accompanying drawings, and wherein:

FIG. 1 is an isometric view of a first embodiment of the inventive BTB dual display computer architecture in the third, fully open collaborative position, showing the secondary screen in the second, intermediate vertical GEM position;

FIG. 2 is a side elevation of the inventive BTB dual display computer architecture in the first, closed, portable configuration with the secondary and primary screens folded face-to-face;

FIG. 3 is a vertical, back elevation view of a second embodiment of the inventive BTB dual display computer architecture in which the secondary screen is pivoted at one side of the primary screen in a SBS GEM position;

FIG. 4 is a top view of the second embodiment of the inventive BTB dual display computer architecture in which the secondary screen is rotated on the medial side pivot to face opposite the user keyboard;

FIG. 5 is an isometric view of the second embodiment of FIGS. 3 and 4 showing the view of the primary screen and keyboard module by the user, with the tilt of the secondary screen being adjustable by the customer to an ergonomically comfortable angles;

FIG. 6 is a third embodiment of the inventive BTB dual display computer architecture in which the secondary screen is hinged at the top and which includes a snap-on protective screen cover;

FIG. 7 is a partial close-up view of the hollow hinge structure of the first embodiment;

FIG. 8 is a partial close-up side elevation view in section of the hollow pivot structure of the second embodiment taken along the line 8-8 of FIG. 4; and

FIG. 9 is a side elevation view of a fourth embodiment of the BTB dual display computer architecture having a free floating secondary screen with integral hook(s) at the top to engage the primary screen and non-skid, length-adjustable feet on the bottom to maintain a comfortable viewing angle.

### DETAILED DESCRIPTION, INCLUDING THE PRESENTLY-KNOWN BEST MODE(S) OF CARRYING OUT THE INVENTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention. In particular, the invention is shown in several embodiments, each being exemplary best mode applications of the inventive system and method as applied to a specific machining task or type of operation.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Accordingly, the best mode embodiment of one feature may be shown in one drawing, and the best mode of another feature will be called out in another drawing.

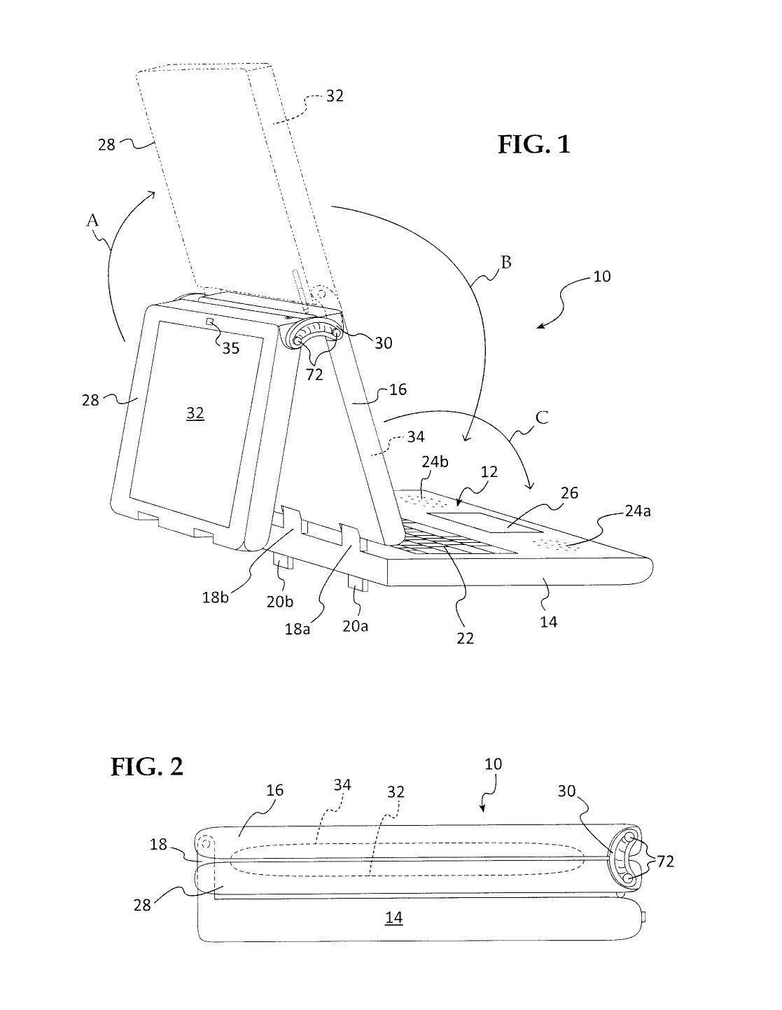

Referring to FIG. 1, the presently preferred embodiment of the inventive BTB dual monitor system 10 comprises a modified laptop architecture 12, having a keyboard module 14 and a primary display module 16, hinged to the keyboard module by vertically extended hinges 18a, 18b. The keyboard module 14 may include fold-out feet 20a, 20b. As shown the keyboard module also includes a standard or virtual keyboard area 22, speakers 24a, 24b and a touchpad area 26. Interior of the keyboard module (not shown) are the conventional devices, including CPU, memory, graphics card(s), power supply, battery, media drive(s), such as CD, DVD, BluRay and the like, media stick readers, and the like. The exterior of the back and sides of the keyboard modules include I/O port connectors, USB, FireWire, wireless card slots, mouse plug-ins, external power cord connectors, and the like. The graphics card has the capacity to support two monitors, and the operating software selectively permits operating both screens in identical or different rendering modes.

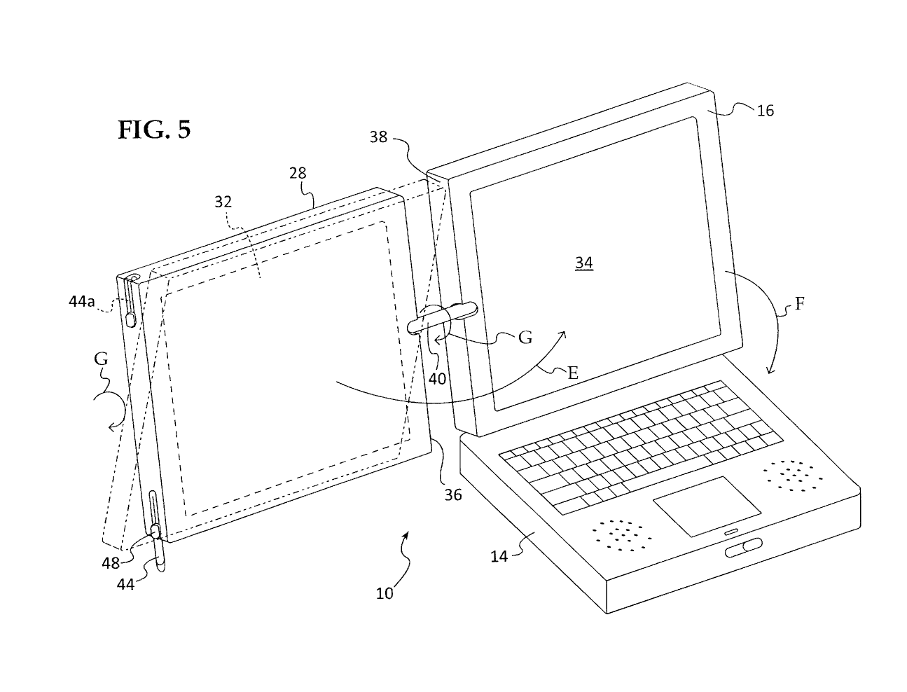

Continuing, the inventive BTB dual monitor system includes a secondary display module 28 that, in this embodiment, is hinged at the top side corners by hinges 30 that permit a full ±180° rotation, as shown by study of both FIGS. 1 and 2. As shown in FIG. 1, the secondary display screen 28 has been rotated around so that the screen 32 faces a customer/client/student, while the primary screen 34 (not shown in this figure, but see FIG. 5) faces the user, the person using the keyboard module 12. The hinges 30 optionally include hollow rivets 72 (see FIG. 7) through which the data and power cable passes from the primary module 16 to the secondary 28 while functioning as pivots. Alternately, the rivets 72 may be hollow tubes that are externally threaded and include external knurled or fluted knobs that may be tightened by hand to position the secondary screen 32 in any position relative to the primary screen 34.

As shown in phantom in FIG. 1, the secondary display module 28 has been rotated up as shown by Arrow A to a SBS GEM position above the primary screen with the secondary screen 32 facing the user. Thus the user sees both primary and secondary screens, 34, 32, and may select to spread the graphics being seen over both screens.

Thereafter, the secondary screen module 28 may be rotated down so that the screens 32, 34 face each other, as shown by Arrow B. To complete stowing the laptop, the combined display modules 16, 28 are folded down as shown by Arrow C. The result is the “letter” folded assembly as shown in FIG. 2. Each of the display modules 16, 28 may include cameras 35. One or both screens 32, 34 may be touch screens.

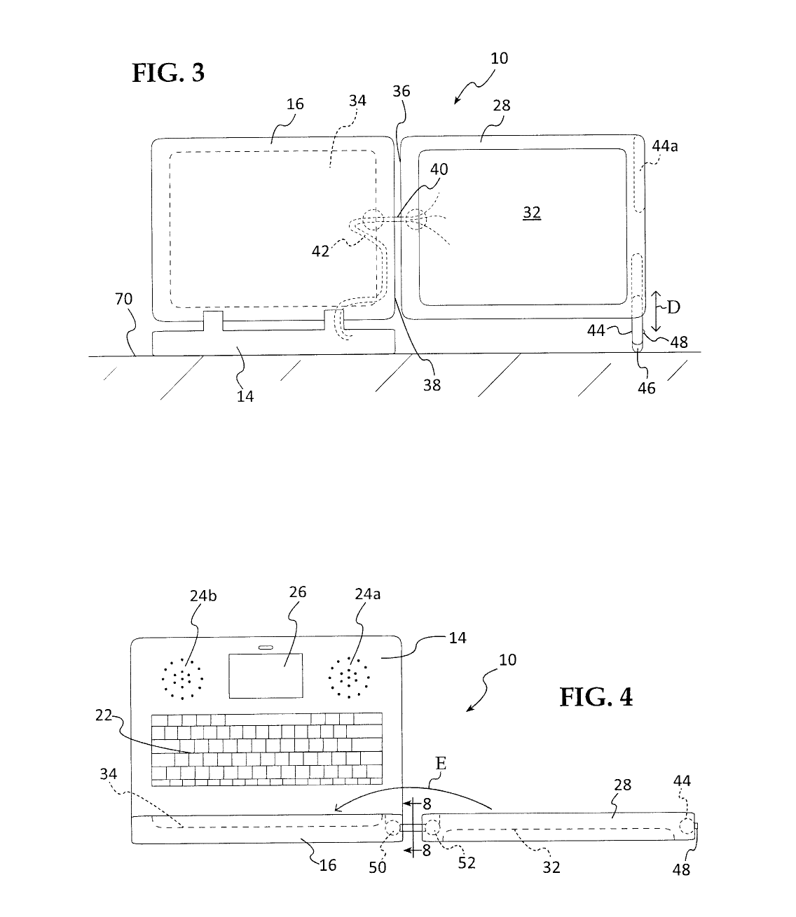

FIG. 3 illustrates a second embodiment, in which the secondary display module 28 is rotationally hinged along one side margin 36 to a side margin 38 of the primary display module 16 by a hollow ball and tube hinge 40 (dogbone pivot). The cabling 42 from the CPU, power supply and graphics cards in the keyboard module 14 is threaded through the axially hollow ball and tube hinge 40 to the appropriate screen connectors in the secondary display module 28. A retractable foot 44 is located on the outboard edge of the secondary display module 28 which can be extended as shown by Arrow D to support the secondary screen module as it is cantilevered off the side 38 of the primary screen module 16. The bottom tip may include a non-skid coating 46, and a projection or knob 48 acts as a finger-hold to assist in extending and retracting the foot 44. Note there is a second, identical retractable foot 44a at the top corner of the secondary screen. This comes into use when the secondary display module 28 is pivoted along the horizontal axis of the tube 40 so the screen 32 faces the user in the SBS GEM orientation.

FIG. 4 is a top view showing the primary screen 34 facing the user as he/she accesses the keyboard module 14, while the secondary screen 32 is rotated ±180° to face a client/customer/student. To close the laptop from the collaborative face to face system (user to customer), the secondary screen is rotationally pivoted on the hollow tube 40 so that the screen 32 faces the user in an SBS GEM orientation. The user can use both screens in this position, so the inventive computer system 10 is in fact a dual use system, both BTB and SBS.

Then the secondary screen is pivoted on the ball ends 50, 52 and folded over so that the two screens 32, 34 face each other as shown by Arrow E, see also FIG. 5. Then that dual screen sandwich is folded down over the keyboard module 14 as shown by Arrow F in FIG. 5, the result being the “letter” fold look of FIG. 2.

Continuing with FIG. 5, note that the secondary screen can be pivoted around the horizontal axis of the tube pivoting hinge 40, as shown by Arrow G, so that the angle of the secondary screen is ergo-nomically comfortable for the client/customer/student.

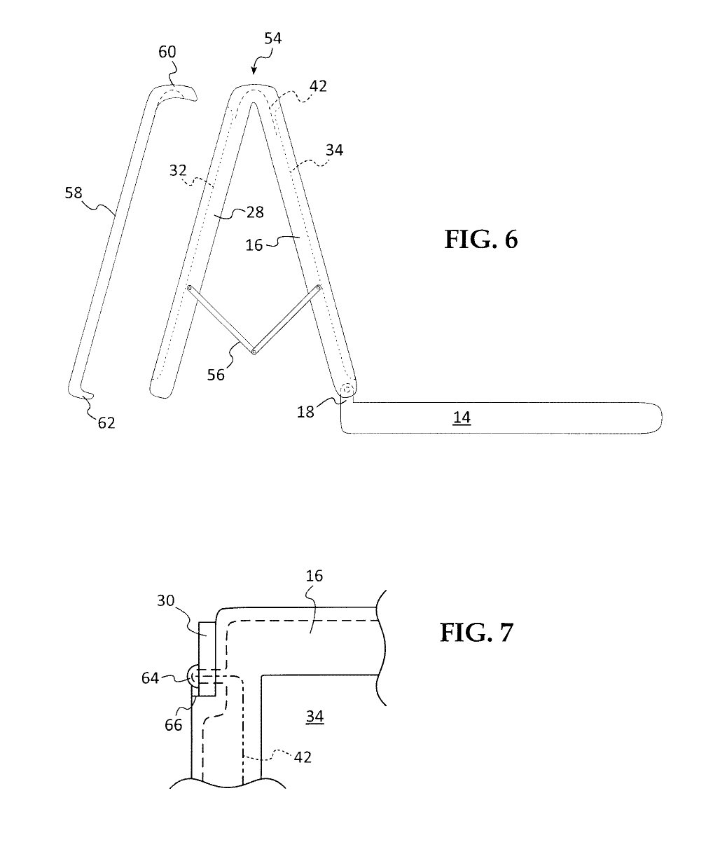

FIG. 6 is a side elevation of another embodiment, in which the secondary screen module 28 is hinged at the top 54, e.g. by a living hinge, the viewing angle being adjusted by a pair of side support hinges 56 (in the nature of elongated bifold scissor hinges). The secondary screen 32 is protected by a hard-shell cover 58 of rigid plastic, which includes a mating hook 60 at the top and a snap catch 62 at the bottom. Optionally there may be side catches in addition to or in the alternative to the bottom catch 62.

FIG. 7 is an enlarged front elevation of the top left corner of the first embodiment of FIG. 1. This shows that the hollow hinge 30 is pivoted at each end by hollow rivets 64, and the shoulder 66 limits the travel of the hinge for floating support of the secondary screen in the position shown in FIG. 1.

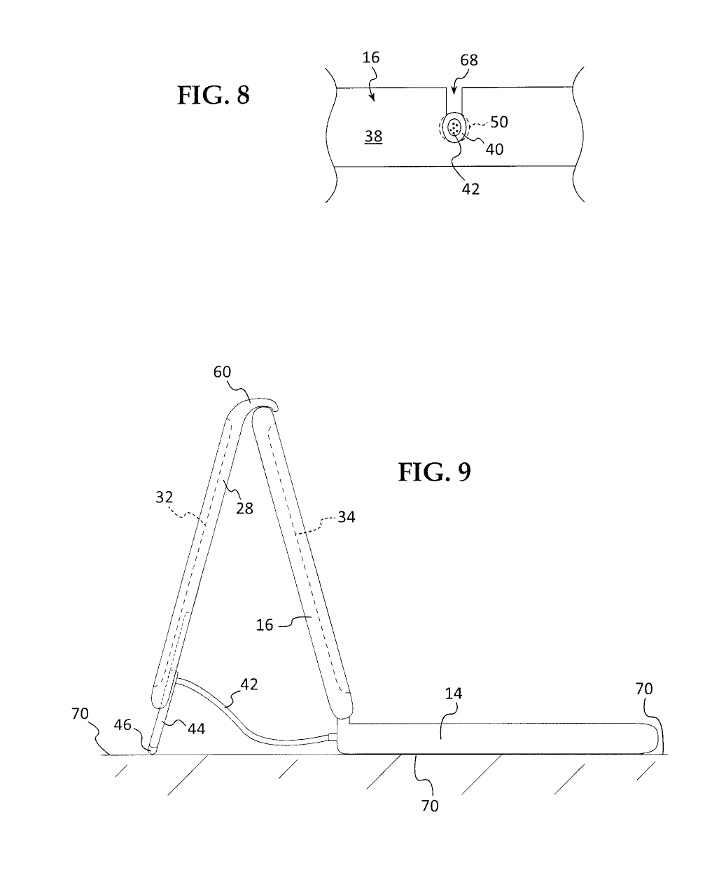

FIG. 8 is a section view through the hollow ball and tube pivot 40 of the second embodiment, taken along the line 8-8 of FIG. 4. This shows that the tube 40 is recessed in slot 68, while the end balls 50, 52 are captured in circular recesses in the respective side walls 38, 36 of the two display modules 16, 28.

FIG. 9 shows still another embodiment in which the secondary display module 28 is free-floating, being secured to the top of the primary module 16 by a hook 60, and the viewing angle is selected by extending the retractable foot 44 to the desk or table (support surface) top 70. The power/data cable is plugged into the exterior I/O port on the back of the keyboard module 14.

### INDUSTRIAL APPLICABILITY

It is clear from the above description and the drawings that the inventive robust, light weight BTB dual screen monitor system will find rapid acceptance as a unique and ideal solution for educational and service professionals for interactive presentations to clients, customers and prospects. In addition, the inventive system permits the secondary screen module to be rotated between BTB collaborative orientation to SBS GEM orientation. Thus the inventive monitor is also dual use.

No prior art monitor system has features permitting the user to continue facing the person(s) to whom a presentation is being given while those persons can see exactly what the presenter/user is seeing, yet providing the vital face-to-face interaction of the parties. Those skilled in the art of electronics will readily recognize that the several components employed in the inventive monitor system may be selected and varied as a basis for straight-forward design of a wide range of equivalent structures to meet the purposes of the present invention.

Accordingly, various modifications within the scope of this invention can be made by one of ordinary skill in the art without departing from the spirit thereof and without undue experimentation. This invention is therefore to be defined by the scope of the appended claims as broadly as the prior art will permit, and in view of the specification if need be, including a full range of current and future equivalents thereof. Any phrase or term utilized herein is for the purpose of description and should not be regarded as limiting.

### PARTS LIST

### This Parts List is Provided as an Aid to Examination and May be Canceled Upon Allowance

10 Inventive back to back dual monitor system
12 modified laptop architecture
14 keyboard module
16 primary display module
18a, b stand-off hinges
20a, b fold-out feet
22 keyboard area
24a, b speakers
26 touchpad
28 secondary display module
30 corner hinges
32 secondary screen
34 primary screen
35 camera
36, 38 sides, primary and secondary display modules
40 hollow ball and tube (dogbone) pivoting hinge
42 screen power and graphics data cabling
44a, b retractable feet
46 non-skid coating on tip of foot 44
48 slider knob
50 hollow ball end of pivot
52 hollow ball end of pivot
54 top hinge, e.g., living hinge
56 side support, bi-fold scissor hinge
58 hard shell protective screen cover
60 mating hook
62 snap catch
64 hollow rivets
66 shoulder, limits travel of corner hinge 30
68 slot
70 support surface, table or desktop
72 hollow threaded (tightenable) pivot with exterior knob
74
76
78
80
82
84
86
88
90
92
94
96
98
100
102
104
106
108
110
112
114
116
118
120
122
124
126
128
130
134
136
138
140
142
144
146
148
150

1. A portable laptop architecture having BTB dual screens, a primary, user screen and a secondary screen viewable by a client/customer/student in face to face collaborative relationship to the user.

2. A portable monitor system as in claim 1 wherein said secondary screen is rotatable from the BTB collaborative position to an SBS GEM orientation.
